(19) United States
(12) Patent Application Publication
(10) Pub. No.: US 2020/0221711 A1
(43) Pub. Date: Jul. 16, 2020

(54) FLOUR DUST CONTAINMENT SYSTEM

(71) Applicant: Michael D. Ordway, Lowell, MI (US)

(72) Inventor: Michael D. Ordway, Lowell, MI (US)

(21) Appl. No.: 16/249,265

(22) Filed: Jan. 16, 2019

(51) Int. Cl. A21C 1/14; B01F 15/00

(52) U.S. Cl. CPC A21C 1/1485; B01F 2215/0011; B01F 15/00961; A21C 1/1495

(57) ABSTRACT

A dust containment system is provided for containing, collecting and extracting airborne contaminants produced during the operation of a machine, such as a bread dough mixer. The containment system includes a hood to fit over the upper portion of a bread mixer to envelop the space above the mixing bowl in order to contain flour dust produced during dough mixing. A vacuum system may be attached to an exhaust port in the hood to create a negative pressure differential on the interior of the containment system and to extract airborne flour dust. A control access panel through the hood is provided to allow a user to operate the control switch of the bread mixer without removing the containment system from the machine.

### FIELD OF THE INVENTION

The present invention is directed to dust containment systems, and in particular to flour dust containment systems for kitchen mixers.

### BACKGROUND OF THE INVENTION

Contaminants in the air, such as dust, can cause health problems for individuals or employees that are exposed to such contaminants. Kitchen appliances, such as bread dough mixers, often produce airborne flour dust as a byproduct of the mixing process. Airborne dust produced in a kitchen or factory can contaminate other surrounding areas, potentially spreading dangerous allergens. In particular, flour dust in commercial kitchens creates messes throughout the kitchen and causes health concerns for employees.

### SUMMARY OF THE INVENTION

The present invention provides a dust containment system for managing airborne contaminants such as the dust created during the mixing of flour into dough. The containment system provides a containment hood or cover for placement over the top of a mixing machine in order to contain a majority of airborne flour dust particles that are produced during the mixing of dough and other food products containing flour. The containment system includes an exhaust port in the hood or cover to allow for connection of a vacuum system for extracting a majority of the airborne flour dust from the interior of the containment system. Optionally, the containment hood includes a control access port through the hood to allow a user to operate the controls of the mixer without removing the containment system from the mixer.

In one form of the present invention, a dust containment system includes a containment hood and an exhaust port. The containment hood is configured to fit over and around the upper portion of a mixer to contain airborne flour dust produced during the operation of the mixer. The exhaust port is defined by a hole through the containment hood and is configured to facilitate connection of a vacuum system to extract airborne flour dust from the interior of the hood.

According to one aspect, the containment hood is defined by four side panels and a top panel. The containment hood has an opening in the bottom in order to fit over the top of a mixer. The bottom opening is defined by the bottom perimeter of the four side panels. The four side panels and the top panels may be constructed from structural foam having sufficient rigidity to resist folding or collapsing due to a negative pressure differential between the exterior and interior of the containment system. The side panels and top panel are covered in a flexible material such as canvas, leather, or fabric. The exhaust port is defined by a hole through one of the side panels and is configured to accept a fitting apparatus for connecting a vacuum system to the containment system. The fitting apparatus includes a threaded adapter attached to one end of a hose of the vacuum system, the threaded adapter then fits through the exhaust port from the exterior side of the containment hood and is secured on the interior side of the hood by a threaded nut.

According to another aspect, the containment hood is defined by a rigid support frame and a flexible material cover enveloping the top and sides of the support frame. The containment hood has an opening in the bottom of the support frame and cover to fit over and around the top or the upper portion of a mixer. The bottom opening is defined by the base of the support frame. The exhaust port is defined by a hole through the side of the cover and is configured to accept a fitting apparatus for connecting a vacuum system to the containment system. The fitting apparatus includes a threaded adapter attached to one end of a hose of the vacuum system, the threaded adapter then fits through the exhaust port from the exterior side of the containment hood and is secured on the interior side of the hood by a threaded nut.

According to yet another aspect, a control access port is defined by a hole through the containment hood and configured to correspond with the location of the machine controls relative to the placement of the containment system on the machine. The access port allows a user to reach through the containment hood to operate the machine controls without the need to remove the containment system from the machine. A sealing flap may be provided over the exterior of the control access port to ensure a sealed environment on the interior of the containment system. The sealing flap may be attached to the side panel by a living hinge defined by the fabric material covering the side panel. The sealing flap may also be attached by a mechanical hinge.

Therefore, the present invention provides a dust containment system for containing and extracting airborne flour dust produced during the mixing of dough and the like. The dust containment system is configured to be sufficiently lightweight and maneuverable to be placed over the machine and removed from the machine by one user, and optionally permits access to the mixer controls through a wall of the containment system while installed.

These and other objects, advantages, purposes, and features of the present invention will become more apparent upon review of the following specification in conjunction with the drawings.

### BRIEF DESCRIPTION OF THE DRAWINGS

FIG. 1 is a perspective view of a flour dust containment system, in accordance with the present invention, shown mounted to a mixer;

FIG. 2 is a bottom view of the hood of the flour dust containment system, including a mixing bowl upper perimeter in phantom;

FIG. 3 is a front view of the hood of the flour dust containment system, shown fitted to the mixing bowl;

FIG. 4 is an exploded perspective view of a vacuum connection fitting apparatus and hood wall section of the flour dust containment system; and

FIG. 5 is a perspective view of the hood of the flour dust containment system in phantom lines fitted to a dough mixer.

### DESCRIPTION OF THE PREFERRED EMBODIMENTS

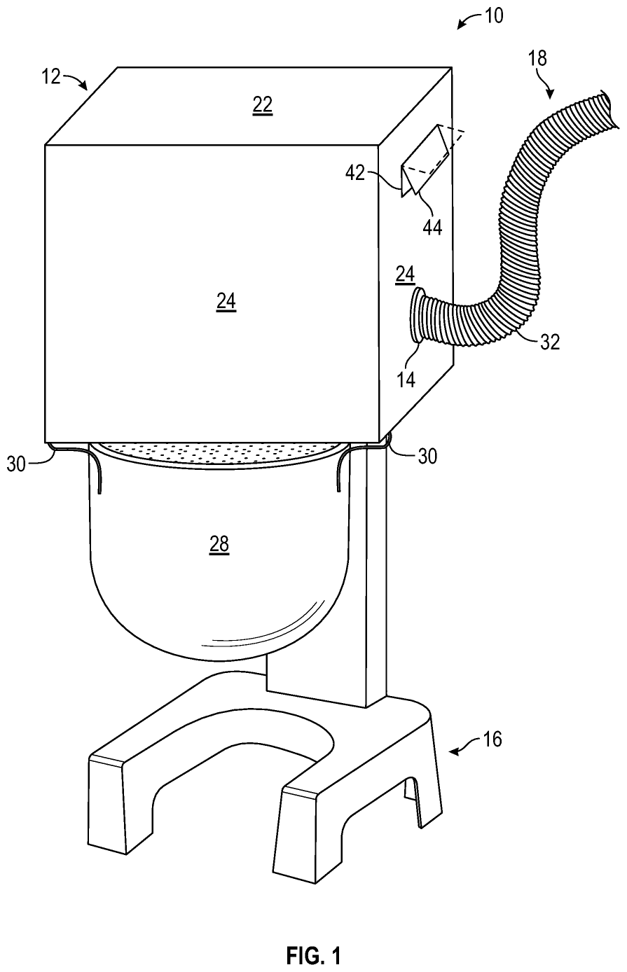

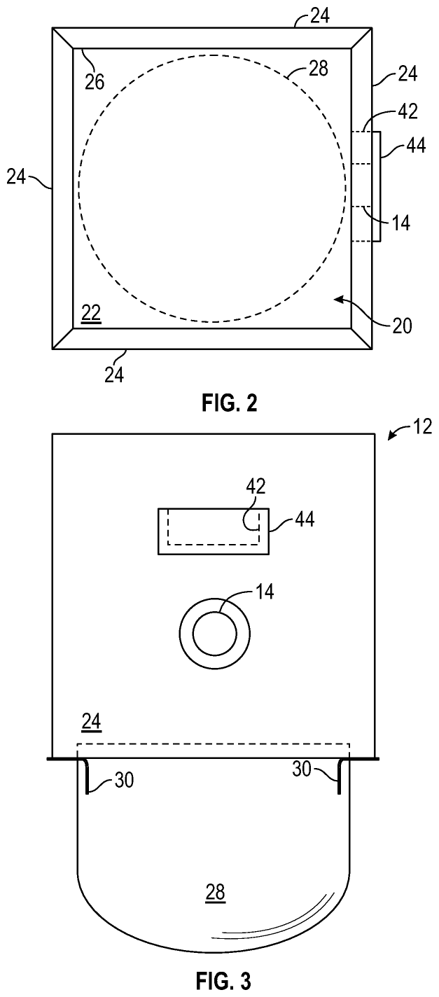

Referring now to the drawings and the illustrative embodiments depicted therein, a flour dust containment system 10 provides for containment and collection of airborne contaminants, such as flour dust that is ejected from a mixing bowl during a mixing process (FIG. 1). The containment system 10 includes a containment hood or cover 12 having an exhaust or extraction port 14. The hood 12 rests over a mixer or machine 16, such as a bread dough mixer, and provides an interior containment environment around at least a portion of the mixer 16. A vacuum system 18 connects to the exhaust port 14 in order to extract dust from the interior of the hood 12. The vacuum system 18 creates a negative pressure differential between the interior and exterior of the hood 12, such that air around the exterior of the hood 12 is drawn upward through a bottom opening 20 in the hood 12 (FIG. 2) and extracted through the exhaust port 14 when the vacuum system 18 is in operation. The negative pressure differential on the interior of the hood 12 provides lift to airborne particles at the bottom of the hood 12 in order to prevent the particles from escaping through gaps between the hood 12 and the mixer 16, so that the vacuum system 18 can extract the airborne particles from the interior of the hood 12 through the exhaust port 14.

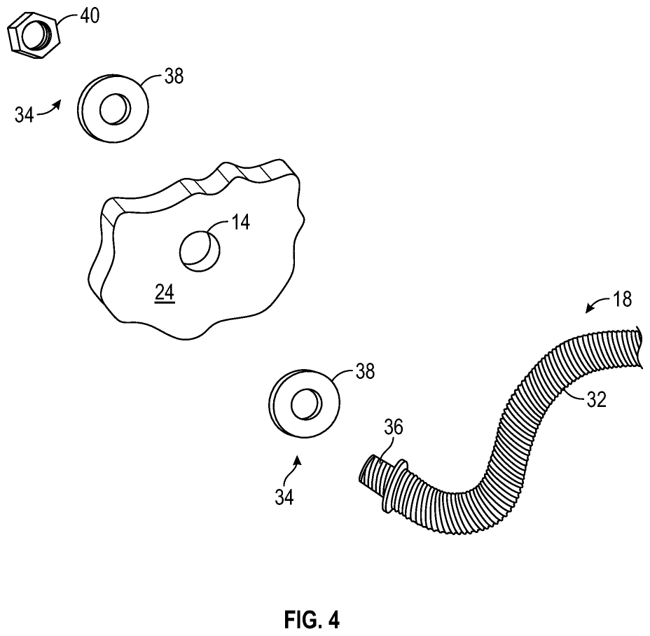

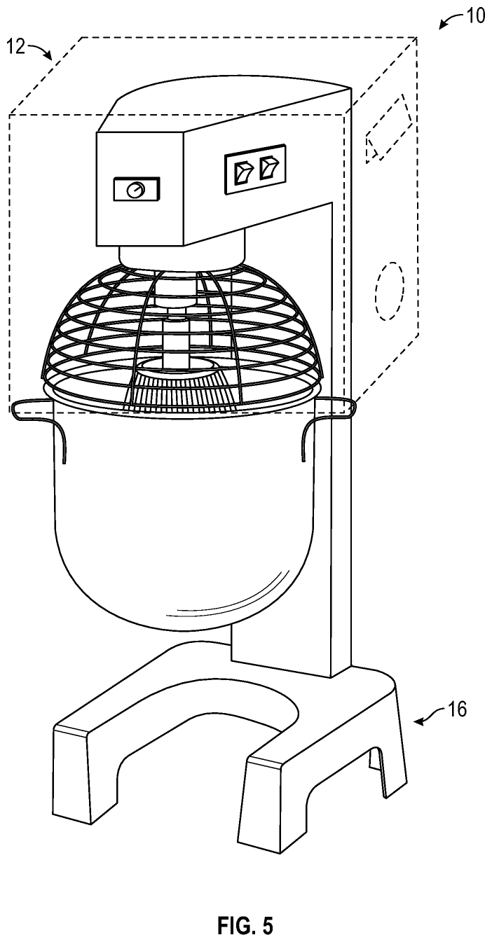

The hood 12 is sufficiently rigid to resist collapse due to the pressure differential between the exterior environment and the interior environment when the vacuum system 18 is operating. The hood 12 may be constructed from structural foam, or may be made from a more flexible material supported by a structural frame, or may include similar support in order to provide adequate rigidity. Optionally, and as shown, a top panel 22 and four side panels 24 cooperate to define the hood 12 (FIGS. 1 and 2). Bottom edges or bases of the side panels 24 cooperate to form or define an inner perimeter 26 that further defines the bottom opening 20 of the hood 12 (FIG. 2). The top panel 22 and side panels 24 may be connected to each other by thread, glue, mechanical fasteners such as brackets and screws, tape, or the like. The bases of panels 24 are configured such that the inner perimeter 26 is larger than the outer diameter of a mixing bowl 28 used with the mixer 16. The size difference between the inner perimeter 26 of the opening 20 of the hood 12 and the mixing bowl 28 outer diameter leaves gaps that allow air to flow from the exterior environment around the bottom of the hood 12 and the exterior of the bowl 28 to provide lift to airborne particles in the interior of the hood 12. The bases of some of the panels 24 may rest on respective handles 30 of the bowl 28 (FIGS. 1 and 4). Optionally, the hood 12 may be an alternative shape generally following the profile of the mixer or machine 16, such as a cylinder shape, an oval shape, a sphere shape, a box shape having a curved top, or the like.

The exhaust or extraction port 14 is a hole defined in one of the side panels 24 such that the vacuum system 18 may be connected to the hood 12. Optionally, and as shown, the hole of the exhaust port 14 is circular (FIG. 4). A hose 32 of the vacuum system 18 may be fixedly connected to the exhaust port 14. Optionally, and as shown in FIG. 4, a vacuum connection fitting apparatus 34 is connected to hose 32 to facilitate connecting the vacuum system 18 to the side panel 24 having the exhaust port 14. Fitting apparatus 34 includes a threaded adapter 36, a set of circular washers 38, and a threaded locking nut 40. The threaded adapter 36 is connected to an intake end of hose 32, and is configured to pass through one of the washers 38 and then through the hole of exhaust port 14. Another washer 38 is fitted around threaded adapter 36 on the interior of the hood 12 and then locking nut 40 is threaded onto adapter 36 to secure hose 32 onto the side panel 24.

An access port 42 is defined by a hole or opening formed in one of the side panels 24, such that a user may put their hand and arm through the access port 42 and operate the controls of the mixer 16 (FIG. 3). A sealing cover flap 44 provides a sufficiently air-tight seal over access port 42 when the flap 44 is in a closed position. Flap 44 may have a perimeter that is the same size or larger than the perimeter of access port 42 to provide an adequate seal during operation of the vacuum system 18. Flap 44 may be attached to one of the panels 24 by a living hinge of the material of the panel, or by a mechanical hinge, by hook-and-loop fasteners, magnets, or substantially any suitable releasable fasteners.

Accordingly, the flour dust containment system provides a simple system for containing and collecting airborne dust particles that are a byproduct of cooking processes, such as mixing bread dough. The containment system includes a lightweight hood to fit over the top of a dough mixer in order to decrease the flour dust dispersed into the local environment around the mixer. A vacuum system is attached and operated to facilitate containment and extraction of flour dust. A negative pressure differential produced by the vacuum system allows lightweight flour dust particles to be drawn from the interior of the hood into the vacuum system. Use of the dust containment system reduces the airborne contaminants within a kitchen and reduces the amount of such contaminants that are inhaled by individuals near the mixer.

Changes and modifications in the specifically described embodiments can be carried out without departing from the principles of the present invention, which is intended to be limited only by the scope of the appended claims, as interpreted according to the principles of patent law, including the doctrine of equivalents.

The embodiments of the invention in which an exclusive property is claimed are defined as follows:

1. A dust containment system comprising:
a containment hood, configured to fit over and around an upper portion of a mixing machine and contain and collect airborne contaminants produced by the mixing machine;
an exhaust port disposed through said containment hood; and
a connection fixture at said exhaust port for coupling to a vacuum system that is operable to extract the airborne contaminants from said hood.

2. The dust containment system of claim 1, wherein said hood comprises a plurality of structural panels fixedly connected to one another, said panels defining a bottom opening configured to receive at least the upper portion of the mixing machine.

3. The dust containment system of claim 2, wherein said plurality of structural panels comprise structural foam panels.

4. The dust containment system of claim 1, wherein said hood is defined by a support frame and a flexible covering material disposed over an exterior of said support frame.

5. The dust containment system of claim 1, wherein said connection fixture comprises an adapter and a locking nut, wherein said adapter is configured to connect to a hose of the vacuum system, said adapter fits through said exhaust port and said locking nut is coupled to said adapter to secure the hose to said hood.

6. The dust containment system of claim 1, further comprising a control access port defined by a hole through said hood and configured to allow a user to reach through said access port to operate a control switch of the mixing machine without removing said hood from the mixing machine.

7. The dust containment system of claim 6, further comprising a sealing cover flap disposed over said access port such that said access port is sealed during operation of the vacuum system.

8. The dust containment system of claim 7, further comprising a living hinge securing said cover flap to said hood.

9. A dust containment system comprising:
a containment hood;
an exhaust port disposed through said hood, said exhaust port including a connection fixture for a vacuum system that is operable to extract airborne contaminants from said hood;
a control access port disposed through said containment hood and spaced apart from said exhaust port; and
an access port cover flap coupled to said hood such that a seal is selectively formed over said control access port;
wherein said hood is configured to fit over and around an upper portion of a mixing machine and contain and collect airborne contaminants produced by the mixing machine during operation of the vacuum system.

10. The dust containment system of claim 9, wherein said connection fixture comprises an adapter and a locking nut, wherein said adapter connects to a hose of the vacuum system, said adapter fits through said exhaust port and said locking nut is coupled to said adapter to secure the hose to said hood.

11. The dust containment system of claim 9, wherein said control access port is configured to allow a user to reach through said containment hood to operate a control switch of the mixing machine without removing said hood from the mixing machine, wherein said control access port is defined by a hole through said hood.

12. The dust containment system of claim 9, further comprising a living hinge securing said access cover port flap to said hood.

13. The dust containment system of claim 9, wherein said hood comprises a plurality of structural panels fixedly connected to one another, said panels defining a bottom opening configured to receive at least the upper portion of the mixing machine.

14. The dust containment system of claim 13, wherein said plurality of structural panels comprise structural foam panels.

15. The dust containment system of claim 9, wherein said hood is defined by a support frame and a flexible covering material disposed over an exterior of said support frame.

16. A dust containment system comprising:
a containment hood comprising a plurality of panels connected to one another to define a bottom opening configured to fit over and around an upper portion of a mixing machine, wherein said hood is configured to contain and collect airborne contaminants produced by the mixing machine;
an exhaust port disposed through said hood, said exhaust port comprising a connection fixture for a vacuum system that is operable to extract airborne contaminants from said hood;
a control access port disposed through said containment hood; and
an access port cover flap coupled to said hood and configured to selectively form a seal over said control access port, wherein said access port is configured to allow a user to reach through said access port to operate a control switch of the mixing machine without removing said hood from the mixing machine;
wherein said connection fixture comprises an adapter and a locking nut, wherein said adapter connects to a hose of the vacuum system, said adapter fits through said exhaust port and said locking nut is coupled to said adapter to secure the hose to said hood.
